(19) United States
(12) Patent Application Publication
(10) Pub. No.: US 2026/0119277 A1
(43) Pub. Date: Apr. 30, 2026

(54) PARTIAL ATTRIBUTION OF UNDERLYING RESOURCE CONSUMPTION

(71) Applicant: BMC Software, Inc., Houston, TX (US)

(72) Inventors: Devasia Antony Muthalakuzhy Thomas, San Jose, CA (US); Phani Madhav Chowdary Jasthi, Apex, NC (US); Gunal Kanna Moorthy Kannan, Singapore (SG)

(21) Appl. No.: 18/933,647

(22) Filed: Oct. 31, 2024

(51) Int. Cl. G06F 9/50

(52) U.S. Cl. CPC G06F 9/5094

(57) ABSTRACT

Described techniques include generation of a host-specific power attribution model for a host comprising components, the host-specific power attribution model relating host metrics characterizing operations of the components to host power consumed by the host. Partitioned host metrics of the host metrics that are associated with a workload being executed by the host may be received, and a workload power of the host power that is used by the workload may be determined using the host-specific power attribution model and the partitioned host metrics.

### TECHNICAL FIELD

This description relates to attribution of resource consumption.

### BACKGROUND

Resources, such as computing resources, may be consumed directly, such as an individual physical server executing on a query, and/or indirectly in a nested fashion. For example, a physical server may be used to execute a virtual machine, in which a container may be used to execute a process.

Consequently, it may be difficult to determine the quantity of underlying resources that is indirectly consumed in such a fashion. For example, it may be straightforward to determine an amount of power consumed by a physical server, but it may be difficult or impossible to determine a portion of that power attributable to a particular application or process running in a virtual machine on such a physical server. Moreover, existing techniques for attempting to estimate partial attributions of resource consumption are not sufficiently accurate and are not applicable across many different types of computing or information technology (IT) resources being consumed.

As a result, actions and decisions that are based on, or may be informed by, such attributions may be difficult or impossible to determine and therefore take action upon in a timely manner. For example, many companies wish to reduce their carbon footprint in conjunction with various Environmental, Social, and Governance (ESG) initiatives. However, it is difficult or impossible to attribute carbon emissions without being able to attribute consumption of underlying resources in an accurate and timely manner.

### SUMMARY

A computer program product may be tangibly embodied on a non-transitory computer-readable storage medium and may include instructions that may be executed by at least one computing device. When executed, the instructions may be configured to cause the at least one computing device to generate a host-specific power attribution model for a host comprising components, the host-specific power attribution model relating host metrics characterizing operations of the components to host power consumed by the host. When executed, the instructions may be configured to cause the at least one computing device to receive partitioned host metrics of the host metrics that are associated with a workload being executed by the host. When executed, the instructions may be configured to cause the at least one computing device to determine, using the host-specific power attribution model and the partitioned host metrics, a workload power of the host power that is used by the workload.

According to other general aspects, a computer-implemented method may perform the instructions of the computer program product. According to other general aspects, a system may include at least one memory including instructions, and at least one processor that is operably coupled to the at least one memory and that is arranged and configured to execute instructions that, when executed, cause the at least one processor to perform the instructions of the computer program product and/or the operations of the computer-implemented method.

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram of a system for partial attribution of underlying resource consumption.

FIG. 2 is a flowchart illustrating example operations of the system of FIG. 1.

FIG. 3 is a block diagram of an example implementation of the system of FIG. 1.

FIG. 4 illustrates examples of timing periods for metric aggregation.

FIG. 5 is a flowchart illustrating example operations of the system of FIG. 3 for generating a partial attribution model.

FIG. 6 is a flowchart illustrating a first example use of a partial attribution model of FIG. 5.

FIG. 7 is a flowchart illustrating a second example use of a partial attribution model of FIG. 5.

FIG. 8 is a flowchart illustrating a more detailed example of the flowchart of FIG. 5.

FIG. 9 is a flowchart illustrating example operations for load balancing, using partial attribution models of FIG. 8.

FIG. 10 is a flowchart illustrating example operations for maintenance of the partial attribution models of FIG. 8, including identification of degraded components.

### DETAILED DESCRIPTION

Described systems and techniques provide partial attribution of consumed resources with respect to individual consumers of those resources. For example, a physical device, such as a server or other host device, may be used to provide attribution of consumed resources to virtual machines, containers, or other software. Described techniques enable partial attribution of, e.g., power consumed by the host, to each individual software element. As a result, for example, businesses or other owners of the relevant hardware and software may be able to accurately determine a carbon footprint attributable to individual software elements, even when the relevant physical host includes different types of processors, and/or when the deployed software includes nested software elements.

Attribution of consumed power to individual software elements executing on a physical host may be problematic, because there is no way to directly measure or detect a portion of the measurable power consumed by the host that is attributable to each of the software elements. Therefore, existing techniques for attribution rely on certain assumptions that are not universally valid, and may result in inaccurate estimates of power consumed by a software element(s).

For example, some such approaches rely on multiplication factors determined during a testing phase that are then used at later times to attribute percentages of central processing unit (CPU) used to corresponding power attributions. In other examples, metrics from CPUs and other components may be used to make ratio-based calculations for software elements with respect to a total power being used.

These and similar approaches do not adapt well across many different types of physical hosts and/or across a lifetime(s) of such hosts. For example, many current hosts may use some combination of CPUs, graphical processing units (GPUs), and other custom microchips, and it may be difficult or impossible to determine assumptions needed to use conventional power attribution techniques.

For example, GPUs may consume significantly more power than a corresponding number of CPUs, both directly and indirectly. For example, GPUs may require more power to provide sufficient cooling. Moreover, different hosts, over time and even within a single organization or datacenter, may have different configurations, with different types or ratios of CPUs and GPUs.

Additionally, CPUs, GPUs, and other components may degrade over time. In such cases, hosts may begin to consume or require more power to provide the same type or extent of software (e.g., to provide the same level of processing). For example, more power may be wasted through heat loss.

Further, many types of software are not amenable to power attribution using existing approaches. For example, virtual machines (VMs) are typically allocated a defined amount of processing and memory resources. However, different VMs may actually utilize various different amounts of these assigned resources. Moreover, power usage of VMs and other workloads may vary over time, based on various factors that may include, e.g., an operating state(s) of the underlying hardware.

Consequently, it may not be accurate to attempt to determine power attribution for a VM based primarily on the quantity of assigned resources. To the extent that power attribution is provided using existing methods, resulting measurements are likely to be rough estimates that are determined for relatively lengthy time periods, do not take into account degradation of computing resources over time, and therefore do not provide accurate or timely power attributions that are sufficient to use for, e.g., determinations of relevant carbon emissions.

Described techniques, in contrast, may be used to determine a host-specific partial attribution model that is unique to a physical host and defined using a current configuration of the host. The host-specific partial attribution model may then utilize available metrics gathered with respect to the host to generate partial power attributions for each and all software elements running on the host.

As a result, described techniques provide accurate partial power attributions at a high level of granularity. Additionally, such partial power attribution may be provided in a nested fashion, across multiple software layers, such as virtual machines, containers, applications, and business layers.

For example, using the described techniques businesses running many applications and other software elements across many different physical hosts may be provided with an ability to determine power consumed by each such software element. Therefore, such businesses may then be provided with an ability to make informed decisions with respect to, e.g., reducing their carbon footprint(s), reducing operating costs, and/or otherwise optimizing their business functions.

In some implementations, for example, businesses or other entities may be provided with an ability to dynamically load balance software elements across different hosts, in order to achieve the above goals. For example, businesses may be provided with an ability to detect a software element running on an older, inefficient host and transfer the software element to an available host that is more efficient. In other examples, business may be provided with an ability to predict an impending need to perform such load balancing, or to otherwise dynamically manage a total workload of software elements.

Although described implementations are primarily described with respect to partial attribution of power in the context of a physical host, described techniques may be used in many other environments, as well. For example, described techniques may be used in other implementations such as in metered computing resources, e.g., that may be executing in a cloud environment or on particular processors, to perform partial attribution of costs associated with software elements and therefore allow businesses to transfer computation to a less expensive computing resource.

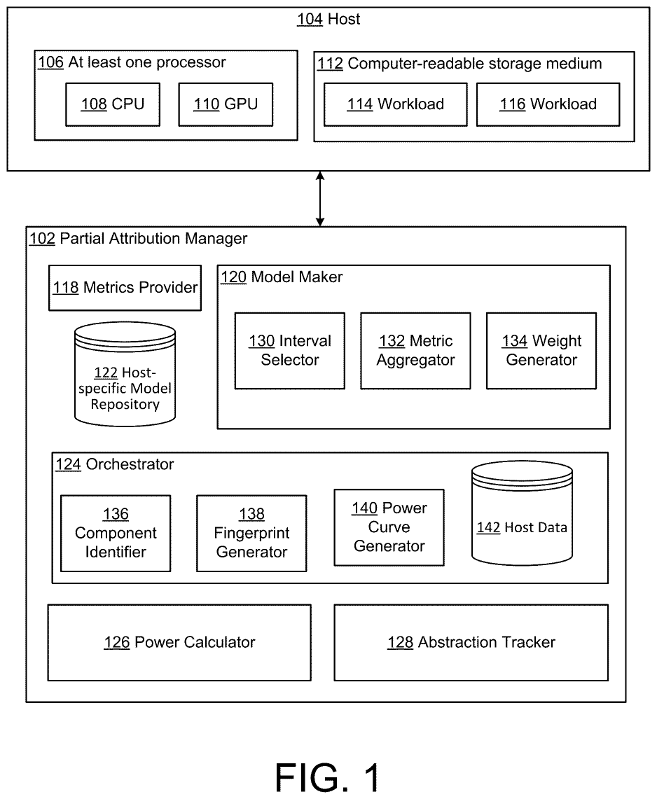

FIG. 1 is a block diagram of a system for partial attribution of underlying resource consumption. In the example of FIG. 1, a partial attribution manager 102 is configured to provide the type of partial attribution of power described above, with respect to each of one or more hosts, represented in FIG. 1 by a host 104.

The host 104 represents any physical computing device that may be configured to execute software, such as a server, workstation, or mainframe. The host 104 may include multiple processors, represented in FIG. 1 by at least one processor 106 that includes at least one central processing unit (CPU) 108 and at least one graphical processing unit (GPU) 110. Each such processor(s) may operate in one or more operating state(s) and may consume varying and various quantities of power or other resource(s).

The host 104 may further include at least one non-transitory computer-readable storage medium 112, representing one or more of the various types of storage or other memory used by the host 104. Each such type, and corresponding instance, of memory hardware, like the at least one processor 106, may consume varying and various quantities of power or other resources(s).

Although not illustrated separately in FIG. 1 for the sake of brevity and clarity, the host 104 may be understood to include many other types and instances of hardware components, such as network cards, cooling systems, and various peripherals, each of which may also consume power to operate. As referenced above, it is straightforward to measure power consumed by the host 104, using standard power measurement tools. In general, host power may vary between a minimum and maximum value, which may be referred to, respectively, as idle or baseline, or peak power values.

For example, the idle power consumed by the host 104 may refer to a baseline quantity of power consumed when the host 104 is turned on and in a state of readiness (e.g., operating system is loaded and basic services are running), but not performing any additional task(s) such as user applications. Maximum or peak power may occur, e.g., in conjunction with full or nearly full utilization of the at least one processor 106, the storage medium 112, and various other components of the host 104.

In the example of FIG. 1, the host 104 is illustrated as executing a workload 114 and a workload 116. The workloads 114, 116 represent any of the types of software referenced above, and described in more detail, herein, including VMs, containers, applications, or other processes.

In the simplified example of FIG. 1, only the two workloads 114, 116 are illustrated, although many different numbers and types of workloads may be implemented. As also referenced herein, each such workload may include or operate a nested workload(s), not shown in FIG. 1.

A quantity of power attributable to the workload 114, as compared to a quantity of power attributable to the workload 116, may vary based on many different factors, not all of which are described herein. In general, the workload 114 may require many more processing cycles of the CPU 108 and/or the GPU 110, as compared to the workload 116. Similarly, the workload 114 may consume more memory or network resources as compared to the workload 116. Moreover, resource consumption of either or both of the workloads 114, 116 may vary considerably over time.

Using described techniques, the partial attribution manager 102 may be configured to attribute power consumption to each of the workload 114 and the workload 116. In the simplified example of FIG. 1, the partial attribution manager 102 is illustrated as being in communication with the host 104. As illustrated or referenced in various examples, below, the partial attribution manager 102 may be implemented in the context of a datacenter providing multiple hosts, and may provide power attribution for each of the multiple hosts. In these or other example implementations, the partial attribution manager 102 may itself be executed on a host or other physical computer, which may itself include the types of processors and memories described herein.

In FIG. 1, the partial attribution manager 102 includes a metrics provider 118. In other example implementations, the metrics provider 118 may be implemented as a component that is external to the partial attribution manager 102. As the metrics provider 118 may provide many different types of metrics, it will be appreciated that the metrics provider 118 may also represent two or more metrics providers, each of which may be included as a component of the partial attribution manager 102 and/or may be implemented using separate hardware, e.g., at the host 104.

The metrics provider 118 may thus be understood to collect and determine many different types of metrics, e.g., in the context of a datacenter. The metrics provider 118 may also provide metrics in response to queries. Such metrics may include, by way of non-limiting example, infrastructure metrics, equipment metrics, security metrics, operational metrics, compliance and/or governance metrics, sustainability metrics, and network metrics.

In more detailed examples, equipment metrics may include utilization metrics, including processor or memory and/or storage utilization metrics. Such metrics may reference percentages of usage, or, in the case of network utilization, bandwidth usage.

In the following description of FIG. 1, the metrics provider 118 is assumed to provide host-specific metrics for the host 104, which are referred to as host metrics. Host metrics may refer to the host 104 as a whole, or may refer to metrics defined with respect to either or both of the workloads 114, 116.

Metrics that refer to an individual workload may be referred to as partitioned host metrics. For example, a first utilization percentage of the CPU 108 may be partitioned and assigned to the workload 114, while a second utilization percentage of the CPU 108 may be partitioned and assigned to the workload 116.

Metrics are typically collected at assigned time intervals. These time intervals may vary among different systems and different components. Some metrics may be “pushed,” meaning that such metrics are automatically generated by a component and sent to the metrics provider 118, while other metrics may be “pulled,” meaning that the metrics provider 118 may request and collect such metrics from relevant components.

A model maker 120 may be configured to generate a machine learning (ML) model that is specific to the host 104, which may be stored in a host-specific model repository 122. Conceptually, such a host-specific model repository 122 inputs metrics from the metrics provider 118 and outputs corresponding power attributions, e.g., for the workload 114 and the workload 116.

An orchestrator 124 may be configured to determine and provide certain types of data to the model maker 120, which may be used by the model maker 120 to generate a host-specific model. The orchestrator 124 may be further configured to coordinate operations of a power calculator 126 in using the host-specific model to calculate power attributions.

An abstraction tracker 128 may be configured to track power attributions with respect to individual workloads. In this context, an abstraction refers to an instance of a defined level or type of workload, which may be implemented at a given host and may be moved from one host to another, or from one workload to another. For example, an abstraction may refer to a virtual machine, or may refer to a container using the virtual machine.

As described in detail, below, an abstraction in this context may be considered to be similar to metrics from the metrics provider 118, except that the abstraction tracker 128 may be configured to track individual abstractions using strings of data characterizing the abstractions with respect to defined time intervals. For example, within a particular start or end time, the abstraction tracker 128 may track characteristics of either or both of the workloads 114, 116.

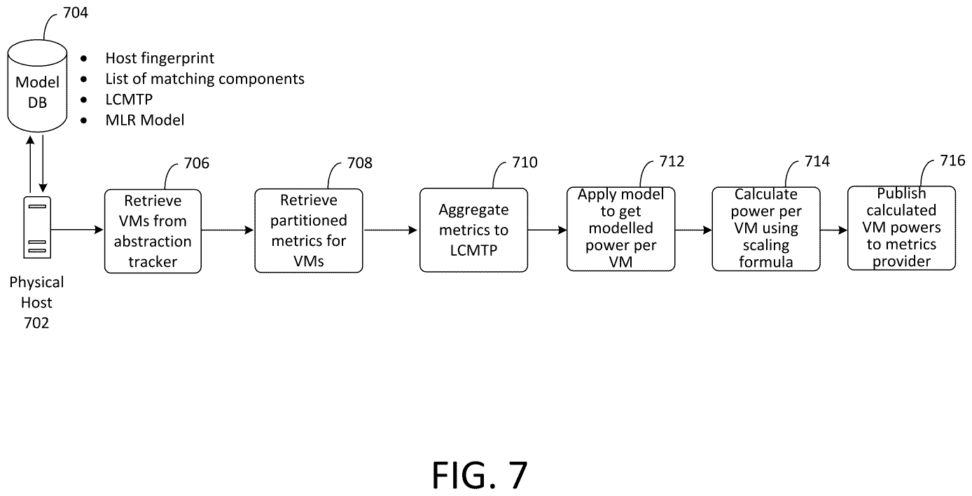

Once the host-specific model for the host 104 is generated by the model maker 120 and stored using the host-specific model repository 122, the power calculator 126 may utilize the host-specific model to make partial attributions of power to each of the workloads 114, 116. In the example of FIG. 1, the power calculator 126 is illustrated as being executed by the partial attribution manager 102 and may communicate with the host 104 and/or the metrics provider 118 to retrieve relevant data to provide to the corresponding host-specific model. In such cases, power calculations may be performed at defined intervals in batch calculations at the partial attribution manager 102 and provided per workload 114, 116, as described in more detail below, with respect to FIG. 7.

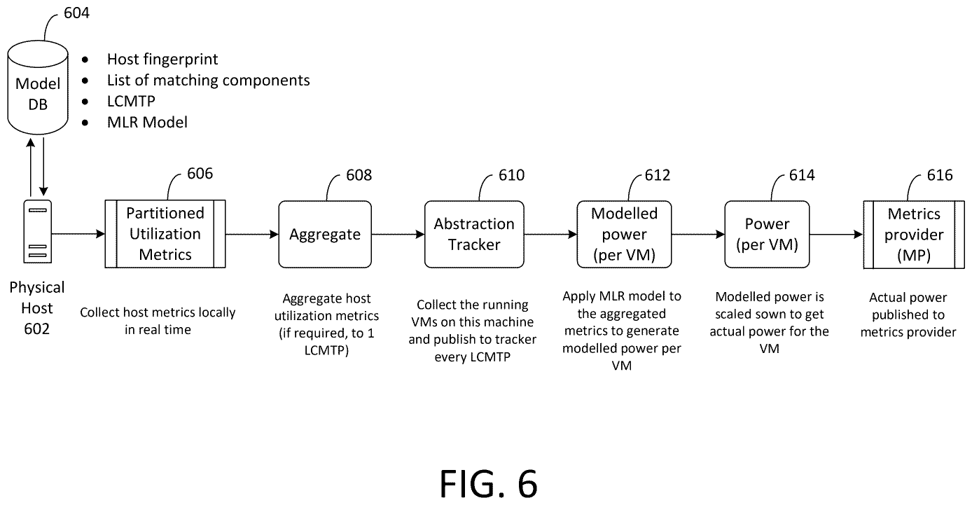

In other examples, the power calculator 126 may be implemented at the host 104, and the partial attribution manager 102 may provide relevant information to the host, such as providing the relevant host-specific model. In such cases, power calculations may be performed inline at the host 104 and provided on a regular basis per workload 114, 116, as described in more detail below, with respect to FIG. 6.

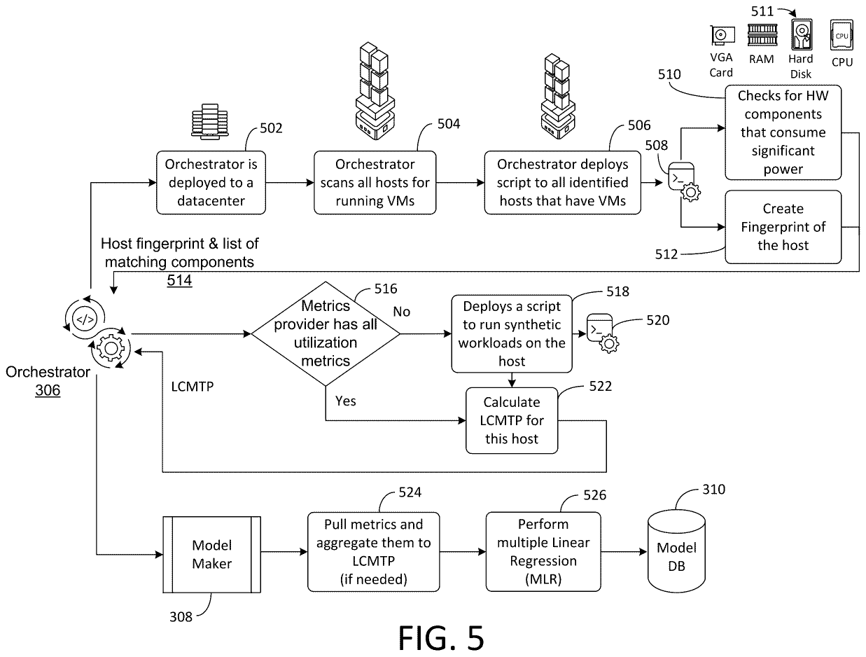

As referenced above, the model maker 120 may be configured to generate a host-specific model for the host 104, as well as for multiple other hosts, e.g., within a datacenter. More detailed examples of operations of the model maker 120 are provided below, e.g., with respect to FIG. 5.

With respect to FIG. 1, the model maker 120 is illustrated as including an interval selector 130, which may be configured to define a common interval of time to be used with respect to aggregating metrics from the metric provider 118. For example, as noted above, the metrics provider 118 generally may output metrics at defined intervals. Such intervals may vary across different metrics, e.g., a first metric may be generated at ‘x’ seconds, while a second metrics may be generated every ‘y’ seconds.

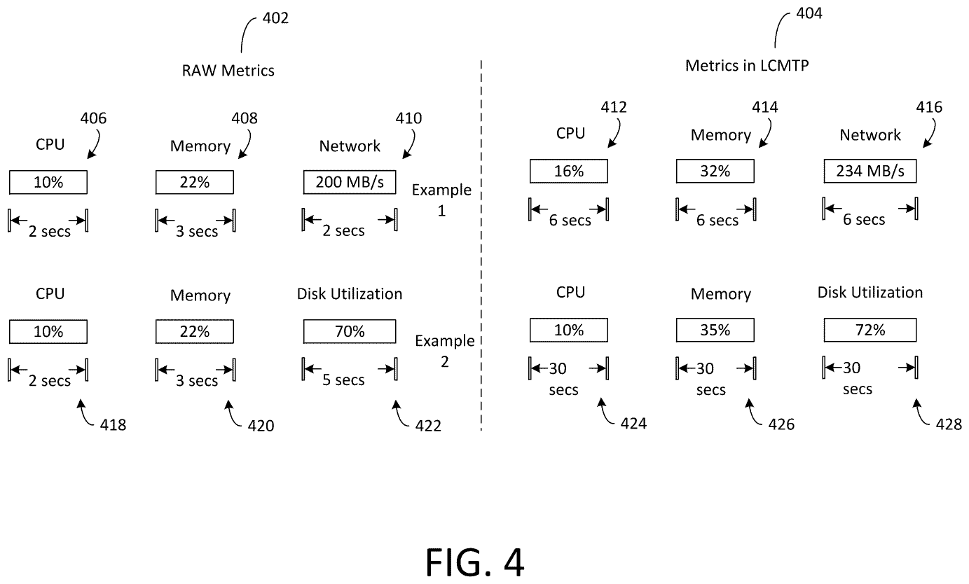

To facilitate aggregation across multiple metrics, then, the interval selector 130 may determine a single interval that is common to all relevant metrics, with respect to a particular a host-specific model being generated. For example, as described below with respect to FIG. 4, the interval selector 130 may determine a least common multiple time period (LCMTP) for a set of metrics.

A metric aggregator 132 may be configured to aggregate relevant metrics to obtain training data, which may then be used by a weight generator 134 to assign weights for, or to otherwise parameterize, the host-specific model being generated for the host 104. For example, as described below with respect to FIG. 5, the host-specific model may utilize multiple linear regression techniques to relate components of the host 104 (and associated component metrics thereof) to power consumed by the host 104. In such examples, the weight generator 134 may be configured to determine and assign weights corresponding to such components, which are thus specific to the host 104 and enable customized power calculations with respect to the host 104.

For example, the orchestrator 124 may include a component identifier 136, which is configured to analyze the host 104 to determine included components that are likely to contribute in a non-trivial way to power consumption of the host 104. For example, the component identifier may identify the CPU 108 and the GPU 110 as contributing to power consumption of the host 104.

Of course, this is a simplified example, and the host 104 may include many other hardware and/or software components that may be associated with the host 104 and determined to contribute to power consumption of the host. The component identifier 136 may be configured to identify a top ‘n’ components of the host 104 with respect to power consumption, where a value of the parameter ‘n’ may be selected in a desired manner to optimize operations of the model maker 120. For example, greater or fewer components may be needed, depending on a desired accuracy level (or other parameter(s)) of the host-specific model being generated.

As already referenced, the model maker 120 may be configured to generate host-specific models for multiple hosts, including the host 104. A fingerprint generator 138 may be configured to generate or assign a unique host identifier or fingerprint that distinguishes the host 104 from other hosts in a manner that also enables determination of any configuration changes that may occur with respect to the host 104 over time.

For example, as described in more detail, below, the fingerprint generator 138 may apply a hash function to component identifiers of the components identified by the component identifier 136, to thereby obtain a unique or nearly unique hash value that corresponds to the particular combination of components of the host 104 that were identified. For example, the host 104 may have a particular combination of different numbers of different types of components, and each component may have its own characteristic(s), manufacturer(s), model number, or other identifying aspects. By applying a hash function to this combination of identifying aspects, the fingerprint generator 138 may output the type of unique host identifier and characterization referenced above.

A power curve generator 140 may be configured to generate a power curve for each component identified by the component identifier 136 and used by the fingerprint generator 138. As also described below with respect to FIG. 5, such component-specific power curves effectively provide a full and complete set of training data for use by the weight generator 134 of model maker 120.

For example, the power curve generator 140 may utilize a synthetic workload executed by one or more components of the host 104, which requires a full utilization of each component of the host 104 across a continuous or near-continuous utilization spectrum of each corresponding component. For example, the power curve generator 140 may use a synthetic workload that requires utilization of the CPU from 0% utilization to 100% utilization, at each utilization level of a continuous (or defined discrete) spectrum of utilization levels. Similar comments would apply to the GPU 110 and various other components of the host 104, including all components identified by the component identifier 136. In more specific examples, the power curve generator 140 may use synthetic workload generator(s) designed for performance testing or evaluation to provide the type of component-specific power curves described herein.

In some example scenarios, it is possible that the power curve generator 140 is not needed to determine a power curve, e.g., for a specific component(s). For example, it may occur that the CPU 108 is utilized across all needed or available utilization states, e.g., as a result of executions of the workloads 114, 116. In such cases, metrics of the metrics provider 118 may provide sufficient information to construct a full power curve for the CPU 108, and the power curve generator 140 may not be needed with respect to the CPU 108.

In many cases, however, it is not typical or possible to determine a full power curve for a given component, or for all needed components, from metrics provided by the metrics provider 118. For example, the workloads 114, 116, during execution, may not require every utilization state of the CPU 108, e.g., may never require CPU utilization above a certain maximum percentage, e.g., 80% utilization.

In such cases, a full or sufficiently full set of training data may not be available to the weight generator 134. For example, if the weight generator 134 is expected to generate weights that accurately characterize all available or possible utilization states of the CPU 108 with respect to a power output of the host 104, then a lack of utilization data at any given utilization state(s) may result in inaccurate or unavailable power outputs being provided by a generated host-specific model.

Moreover, even if a full set of utilization states is provided for a given component, the metrics provider 118 may be unable to provide corresponding full sets of utilization states across all necessary components. In contrast, inclusion of the power curve generator 140 ensures that all needed utilization states of all identified components will be available for use by the model maker 120 in generating each host-specific power attribution model.

Thus, host data 142 may be used to store, for each available host, relevant components and their power curves, as well as a corresponding host fingerprint. Consequently, when calculating power attributed to a given workload (e.g., the workload 114 and/or the workload 116, the power calculator 126 may easily retrieve or determine the relevant host, verify an identity of the host and verify a presence of relevant components using the host fingerprint, and select the correct host-specific power attribution model.

Then, the power calculator 126 may determine current values of corresponding metrics from the metrics provider 118. More particularly, the power calculator 126 may determine partitioned host metrics that, as noted above, characterize current utilization levels of each relevant component of the relevant host (e.g., the host 104). For example, the power calculator 126 may determine a utilization of the CPU 108 by the workload 114, and by the workload 116, with similar partitioned host metrics collected for other relevant components with respect to each of the workloads 114, 116.

Each workload-specific set of partitioned host metrics may then be fed to the corresponding host-specific partial attribution model. For example, partitioned host metrics for the workload 114 may be provided to the host-specific partial attribution model. Since the host-specific partial attribution model was trained to predict power for the host 104, a resulting output of the host-specific partial attribution model will correlate with a quantity of power that would be produced by the host 104 if the workload 114 were the only workload executing on the host 104.

Similar comments apply to the providing of partitioned host metrics for the workload 116 to the host-specific partial attribution model. That is, the host-specific partial attribution model will provide a computed power that would exist if the workload 116 were the only workload being executed by the host 104.

Thus, the power calculator 126 determines a workload-specific-modelled power for each of the workloads 114, 116, using the host-specific partial attribution model. The power calculator 126 may then use a measured actual power of the host 104, in conjunction with the workload-specific-modelled powers, to determine workload-specific power attributions corresponding to actual power consumption of each of the workloads 114, 116.

For example, as described in more detail, below, a scaling formula may be used, in which a workload-specific power (WLₚ) is determined using a ratio of total measured host power (Hₚ) to total workload-specific modelled power (WLₜₘₚ) (i.e., for all workloads), multiplied by each workload-specific modelled power (WLₘₚ) to obtain the corresponding workload-specific power. In other words, in the example, the workload-specific power equals the workload-specific-modelled power times a ratio of the measured host power to the total workload-specific-modelled power, or WLₚ=WLₘₚ (Hₚ/WLₜₘₚ).

This approach takes into account that, as explained above, the host 104 has a baseline or minimum power level, as well as a maximum power level, and that the host-specific power attribution model is constructed for the host 104. Therefore, all modelled powers of the host-specific power attribution model for individual workloads will be within the range of the minimum, baseline power level and the maximum power level, as if each workload were the only workload currently executing. As a result, workload-specific-modelled power may be required to be scaled down as a function of the total measured host power in order to calculate the actual workload specific power of each workload.

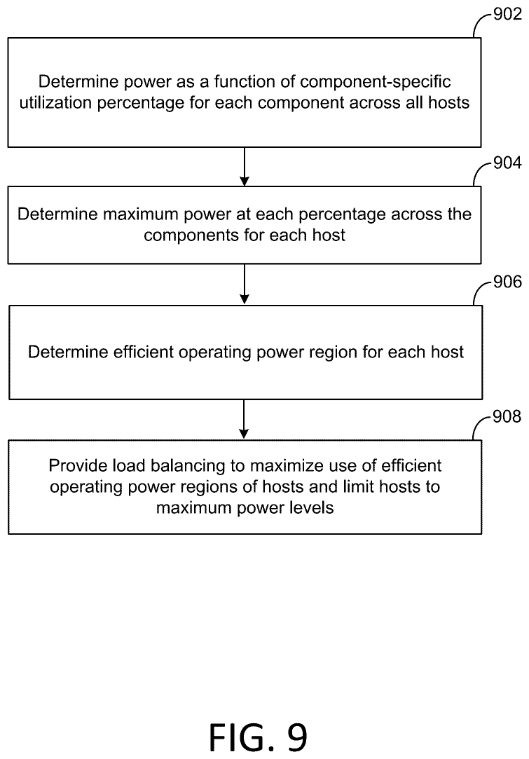

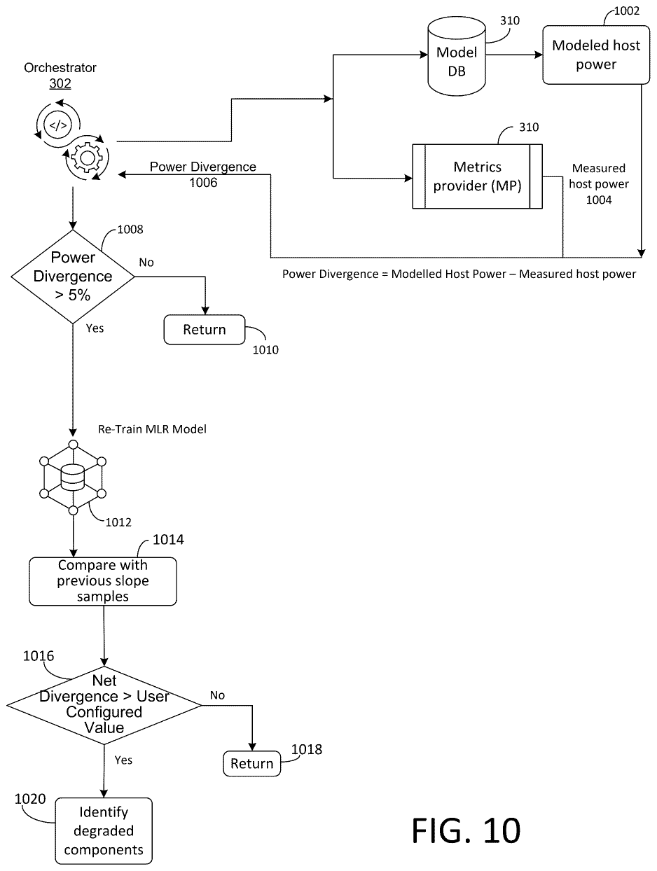

Thus, described techniques enable partial attribution of consumed power by a given workload, regardless of other workloads executing on an underlying host. Moreover, such partial attribution may be provided regardless of which host is currently executing the workload being considered, as long as a host-specific power attribution model is available for each host being used. As a result, it is possible to manage the host 104, or a data center full of hosts, more effectively, including accurate attribution of carbon emissions among executing workloads. Moreover, described techniques may be used to identify degraded host components that may lead to inefficient power consumption, as described with respect to FIG. 9, and/or to perform timely load balancing, as described with respect to FIG. 10.

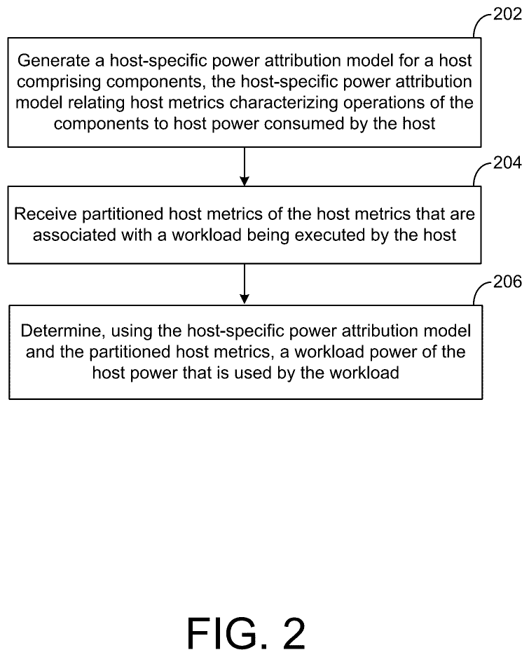

FIG. 2 is a flowchart illustrating example operations of the system of FIG. 1. In the example of FIG. 2, operations are illustrated as separate, sequential operations. In various implementations, the illustrated operations may include sub-operations, may be performed in a different order, may include alternative or additional operations, or may omit one or more operations. Further, in all such implementations, included operations may be performed in an iterative, looped, nested, or branched fashion.

In the example of FIG. 2, a host-specific power attribution model for a host comprising components may be generated, the host-specific power attribution model relating host metrics characterizing operations of the components to host power consumed by the host (202). For example, the model maker 120 may generate a host-specific partial attribution model for the host 104. Components of the host 104 that contribute to power consumption, such as the CPU 108 and the GPU 110, among many other potential components, may be identified. The model may be constructed using multiple linear regression techniques, in which power consumption curves of the components are used as training data to associate weights with the various components. As also described with respect to FIG. 1, a unique host fingerprint or other identifier may be associated with the host 104, and with the host-specific partial attribution model.

Partitioned host metrics of the host metrics that are associated with a workload being executed by the host may be received (204). For example, the power calculator 126, operating either at the host 104 or the partial attribution manager 102, may receive partitioned host metrics from the metrics provider 118 for the workload 114, with respect to the previously identified components used in constructing the host-specific power attribution model. The host fingerprint, which may be stored, e.g., in the host data 142, may be used to verify that the relevant components are still present and in use at the host 104.

Using the host-specific power attribution model and the partitioned host metrics, a workload power of the host power that is used by the workload may be determined (206). For example, the power calculator 126 may provide the partitioned host metrics to the host-specific power attribution model to obtain a workload-specific modelled power for the workload 114 and a workload-specific modelled power for the workload 116. Then, as described above, each actual workload-specific power (WLₚ) may be determined by scaling down the corresponding workload-specific-modelled power (WLₘₚ) using a ratio of the total measured host power (Hₚ) to a total workload modelled power (WLₜₘₚ).

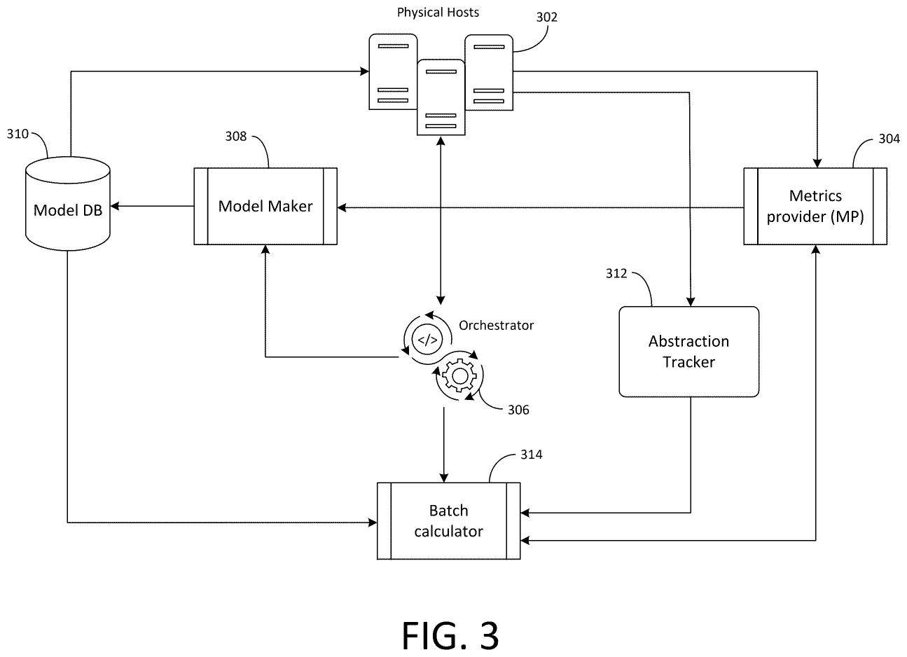

FIG. 3 is a block diagram of an example implementation of the system of FIG. 1. In FIG. 3, physical hosts 302 represent examples of the host 104 of FIG. 1, while a metrics provider 304 provides an example instance of the metrics provider 118 of FIG. 1.

Further in FIG. 3, an orchestrator 306 is illustrated as being in communication with a model maker 308, which is configured to provide the types of host-specific power attribution models described above, for storage using a model database 310. An abstraction tracker 312 may be configured to track virtual machines, containers, services, applications, and other workloads running on the physical hosts 302, including nested workloads.

Finally in FIG. 3, a batch calculator 314 illustrates an example of the power calculator 126 of FIG. 1, which is configured to calculate workload-specific power attributions for all workloads executing on the physical hosts 302. For example, the batch calculator 314 may be configured to apply a host-specific power attribution model to utilization metrics offline, in batch, to calculate underlying resource consumption, which may then be pushed as an accumulating metric of a corresponding abstraction of the abstraction tracker 312 to the metrics provider 304.

More specifically, the batch calculator 314 may utilize an appropriate host-specific power attribution model for a corresponding host, obtained from the model database 310, in conjunction with partitioned host metrics from the metrics provider 304, to determine workload-specific power attributions for workloads of the physical hosts 302. For example, partitioned host metrics may be aggregated over periods or intervals of time for each of a plurality of the physical hosts 302, and batch calculations may be performed to determine workload-specific power attributions according to a defined schedule.

As noted above, the system of FIG. 3 may be installed at the data center level, e.g., a data center in which the physical hosts 302 are deployed. Some of the physical hosts 302 may be more efficient than others, in general or with respect to execution of a particular workload, or type of workload. Such differences in efficiency may result as a design choice by a provider of a physical host or may occur due to degradations of the physical hosts 302 over time.

Using described techniques, it is possible to determine current power attributions of deployed workloads on their corresponding hosts. As the batch calculator 314 determines such power attributions over time (or as power attributions are determined inline at the individual physical hosts 302), it therefore becomes possible to identify hosts that are more efficient than other hosts, hosts that degrade over time, an extent to which each host has degraded, to update corresponding host-specific partial attribution models accordingly, and to transfer workloads among hosts as needed to optimize power efficiencies within the data center in which the physical hosts 302 are deployed.

In the example of FIG. 3, the model maker 308 may utilize linear regression, e.g., multiple linear regression, to generate host-specific power attribution models. In general, multiple linear regression enables determination of an output variable with respect to multiple independent input variables. A multiple linear regression equation may be written as yi=β0+1xi1+β2xi2+ . . . +βpxip+ϵ, where, for i=n observations, yi represents a dependent variable, xi represents explanatory variables, β0 represents a y-intercept (constant term), βp represents a slope coefficients for each explanatory variable, and ϵ represents the model's error term (also known as the residuals).

Various techniques for implementing instances of multiple linear regression are known and may be used, and are therefore not described here in further detail. In some implementations, the β terms in the preceding equation may be collected as weights of the model, which may be expressed in matrix format to facilitate fast and large-scale processing (e.g., matrix multiplication).

As resulting models are specific to their underlying hosts, and due to the types of differences in power consumption that may exist per host, it is possible that a workload running on one host may consume more or less power (as determined by the power attribution model of that host) than would be consumed by the same workload on another host (as determined by the power attribution model of that host). Moreover, similar techniques may be used to attribute resource consumption of other types of resources by individual workloads, including, e.g., carbon consumption or cost and/or financial resource consumption.

FIG. 4 illustrates examples of timing periods for metric aggregation. As noted above, the metrics provider 118 of FIG. 1 or the metrics provider 304 of FIG. 3 generate metrics at defined intervals, and the intervals may vary across different metrics. To facilitate calculations performed by the weight generator 134 and the power calculator 126 of FIG. 1 (and the batch calculator 314 of FIG. 3), a time interval may be selected (e.g., by the interval selector 130 of FIG. 1) that enables a common aggregation across the different types of metric values. Accordingly, processing resources in performing calculations may be conserved, and power measurements may be output at regular, defined intervals.

For example, FIG. 4 illustrates raw metrics 402 and metrics 404 aggregated to a time interval selected as a least common multiple time period (LCMTP) for a set of relevant raw metrics 402. In a first example, labeled as Example 1 in a top row of FIG. 4, relevant raw metrics include a CPU metric 406 that is collected every 2 seconds, a memory metric 408 that is collected every 3 seconds, and a network metric 410 that is collected every 2 seconds. Then, as shown, a LCMTP of 6 seconds may be selected, so that an aggregated CPU metric 412, an aggregated memory metric 414, and an aggregated network metric 416 may be provided every 6 seconds respectively.

As shown in Example 1, the metric values may vary over the raw metric time interval as compared to the same metric values over the LCMTP. For example, the CPU metric 406 shows that CPU utilization is 10% during the raw metric time interval of 2 seconds, while the LCMTP CPU metric 412 shows that utilization is 16% during the LCMTP time interval of 6 seconds. The memory metric 408 shows that memory utilization is 22% during the raw metric time interval of 3 seconds, while the LCMTP memory metric 414 shows that utilization is 32% during the LCMTP time interval of 6 seconds. The network metric 410 shows that network utilization is 200 MB/s during the raw metric time interval of 2 seconds, while the LCMTP network metric 416 shows that utilization is 234 MB/s during the LCMTP time interval of 6 seconds.

Example 2, in a bottom row of FIG. 4, illustrates different example raw metric values with time intervals of 2 seconds, 3 seconds, and 5 seconds for 418, 420, and 422 respectively, and a LCMTP of 30 seconds for each of 424, 246, and 428. As shown, a CPU metric 418 shows that CPU utilization is 10% during the raw metric time interval of 2 seconds, and the LCMTP CPU metric 424 shows that utilization is also 10% during the LCMTP time interval of 30 seconds. A memory metric 420 shows that memory utilization is 22% during the raw metric time interval of 3 seconds, while the LCMTP memory metric 426 shows that utilization is 35% during the LCMTP time interval of 30 seconds. A disk utilization metric 422 shows that disk utilization is 70% during the raw metric time interval of 5 seconds, while the LCMTP disk utilization metric 428 shows that disk utilization is 72% during the LCMTP time interval of 30 seconds.

Accordingly, power calculations may be provided every 6 seconds in Example 1, or every 30 seconds in Example 2. In other example implementations, calculations may be performed over any defined or desired time interval(s), which may require additional calculations and calculation time, but which provides the flexibility of selecting a desired time interval for power reporting.

FIG. 5 is a flowchart illustrating example operations of the system of FIG. 3 for generating a partial attribution model(s) that is specific to a particular host(s). That is, as described with respect to FIG. 3, the orchestrator 306 may facilitate collection of training data needed by the model maker 308 to populate the model databases 310 with host-specific partial attribution models. In the example of FIG. 5, and following examples, description is primarily provided with respect to virtual machines executing on hosts, but it will be appreciated from the above descriptions of FIGS. 1-4 that described techniques may be used with respect to any executing workload.

In FIG. 5, the orchestrator 306 is deployed to a data center (502). The orchestrator 306 is configured to scan all hosts for executing VMs (504). For every host identified as executing one or more VMs, the orchestrator 306 may be configured to deploy a script 508 designed to implement functions of the component identifier 136 and the fingerprint generator 138 of FIG. 1 (506). The script 508 may be configured to run every time the corresponding host restarts.

Thus, as shown, the deployed script 508 may proceed to check each host for hardware components that consume power (510), e.g., beyond a defined threshold. For example, the script 508 may utilize a list of components known to consume power beyond a defined threshold, such as CPUs, GPUs, various types of memories, video graphics arrays (VGA) cards, fans and/or cooling systems, or accelerators, and may identify corresponding components 511 used in each host.

The script may further generate a host fingerprint for each host (512). As described with respect to the fingerprint generator 138 of FIG. 1, any known technique for generating a unique signature or fingerprint may be used, e.g., a hashing algorithm that inputs representations of the components and outputs a unique hash value corresponding to the combination of components. In many cases, hardware components are swappable, or may be updated, replaced, or upgraded, or may otherwise be changed over time. Because power attribution models described herein are host-specific, such changes to a host will render a corresponding partial attribution model unsuitable for that host. Through the use of host fingerprints, then, it is possible to ensure that a correct and applicable partial attribution model is used, including generating a new model when a new fingerprint is detected.

Then, the host fingerprint and list of matching components are provided to the orchestrator 306 for each host (514). The orchestrator 306 may determine whether the metrics provider being used has all necessary utilization metrics for the various components (516). If not, then for each host for which utilization metrics are needed, a script may be deployed to run synthetic workloads on that host (518) to obtain the needed utilization metrics 520. Using the utilization metrics, and as described with respect to FIG. 4, a LCMTP may be calculated for each host (522).

Accordingly, for each host, all necessary training data parameters may be provided to the model maker 308. The model maker 308 may thus proceed to obtain defined metrics and aggregate resulting metric values using the LCMTP (524). The obtained, aggregated metric values may be used as training data to perform multiple linear regression for the relevant host (526), to obtain weights as described with respect to the weight generator 134 of FIG. 1. Resulting weights may be stored as a host-specific power attribution model within the model database 310.

FIG. 6 is a flowchart illustrating a first example use of a partial attribution model of FIG. 5. In FIG. 6, power per VM is calculated using an inline power calculation in which a physical host 602 downloads a corresponding host-specific partial attribution model from a model database 604. For example, the physical host 602 may retrieve a corresponding host fingerprint, a list of matching components, the LCMTP for the metrics corresponding to the components, and the model itself (e.g., including MLR weights previously calculated).

A metrics provider, similar to those described above and executing on the host itself, may be used to obtain partitioned host metrics, also referred to as partitioned utilization metrics (606). As explained above, partitioned host metrics refer to per-VM (or other workload) utilization metrics for the host in question. For example, a full CPU utilization may be 90% for the host as a whole, but each of three executing VMs may utilize 20%, 50%, and 30%, respectively, of the total utilization. Partitioned metrics are typically available on platforms and metric providers can be configured to collect them. Metrics providers executing on the host can collect partitioned host metrics locally in real time using existing metric collection tools.

Collected metrics may then be buffered and aggregated to the previously determined LCMTP (608). At each LCMTP, VMs running on the host may be captured and published to an abstraction tracker (610). As VMs may start and stop over time, the abstraction tracker may be used to track currently executing VMs over multiple LCMTPs.

Then, the previously obtained host-specific power attribution model may be used to determine a VM-modelled power for each executing VM (612), thereby obtaining each individual VM modelled power as well as a total VM-modelled power (determined by summing the individual VM-modelled powers). As described above with respect to a suitable scaling formula, an actual or measured host power may then be used in conjunction with the total VM-modelled power to scale down each individual VM modelled power, to thereby obtain the actual attributed power per VM (614). The obtained actual power per VM may then be published to the metrics provider (616).

FIG. 7 is a flowchart illustrating a second example use of a partial attribution model of FIG. 5. In FIG. 7, power per VM is calculated using a batch power calculation. The approach of FIG. 7 facilitates matrix calculations (e.g., using the weight matrix of MLR models) at scale. For example, batch processing may be configured to process data of a specific duration, such as every 4 hours, or every 8 hours.

In FIG. 7, similar to FIG. 6, a physical host 702 downloads a corresponding host-specific power attribution model from a model database 704. For example, the host 702 may retrieve a corresponding host fingerprint, a list of matching components, the LCMTP for the metrics corresponding to the components, and the model itself (e.g., including MLR weights previously calculated).

For the duration being considered, a list of VMs running per interval may be obtained from the abstraction tracker (706). For the duration in consideration, partitioned metrics of matching components for respective VMs running on the relevant host may be retrieved from the metrics provider (708).

Each metric can have varying sample intervals, and each metric may therefore be aggregated to the LCMTP (710). The relevant host-specific partial attribution model may then be applied to the aggregated metrics to obtain the modelled power per VM for each VM on the relevant host (712).

Each of the modelled powers per VM may be summed to obtain the total modelled VM power, and the actual measured power of the host may be obtained. Then, the calculated power per VM may be determined using the scaling formula described above (714). For example, calculated power for a VM may be determined by multiplying the modelled power for that VM by the ratio of the actual or measured host power to the total modelled VM power. The calculated power per VM for each VM may then be published at the batch frequency or interval to the metrics provider (716).

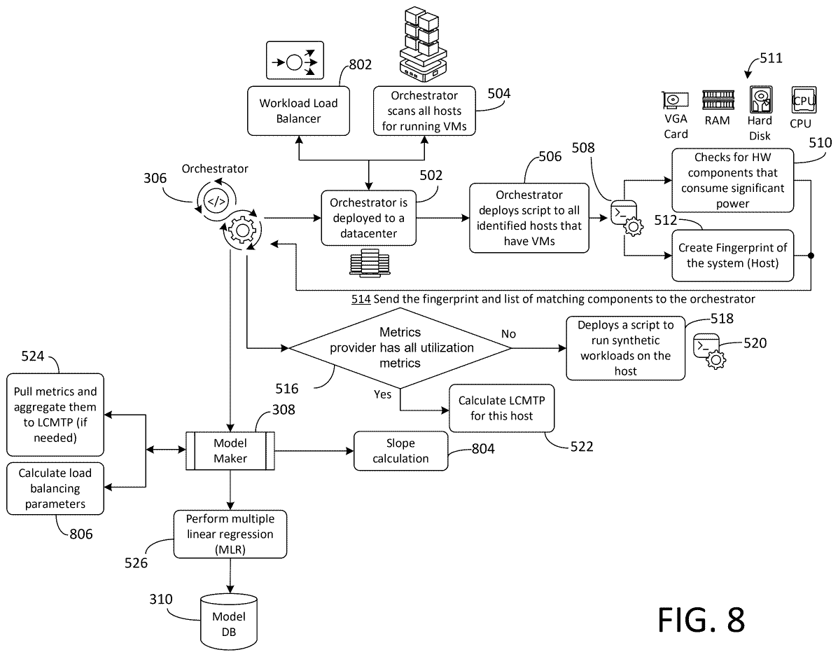

FIG. 8 is a flowchart illustrating a more detailed example of the flowchart of FIG. 5. In the example of FIG. 8, operations and components that are also included in FIG. 5 have reference numerals that are identical to those of FIG. 5, and are not discussed here in detail except as may be helpful in understanding additional operations and components of FIG. 8 that are not included in the example of FIG. 5.

For example, in FIG. 8, a workload load balancer 802 is illustrated that may be configured to utilize determined workload-specific power calculations to deploy or re-deploy workloads in a manner that optimizes power usage within the relevant datacenter and among the various physical hosts of the datacenter. For example, as described in more detail, below, each host may have one or more operating ranges or states that are more power-efficient than other operating ranges or states. The workload load balancer 802 may be configured to move one or more workloads from a first host (e.g., operating in a suboptimal power efficiency range) to a second host (e.g., operating in a more optimal power efficiency range).

For example, just as an automobile may be more efficient at using gasoline at 55 mph than at 20 mph or 80 mph, a physical host may be more energy efficient at some power levels than others. For example, a host operating just above a baseline power level or a host operating near a maximum or peak power level may use energy less efficiently than a host operating at, e.g., 70% of peak power. Therefore, by moving a workload executing on a host operating close to peak power levels to a host operating in a more power-efficient operating range will result in greater energy efficiency for both hosts, and for the datacenter as a whole. Further, the transferred workload itself may consume less energy and have less power attributed to it, thereby reducing costs and a carbon footprint of an owner of the workload.

Although such observations may generally be true, and although various different techniques for load balancing may generally be known, it may be difficult to determine which workloads to relocate and/or which hosts should be selected as sources or targets of transferred workloads. For example, different hosts may have different power consumption characteristics, and, even when the hosts are operating at similar operating ranges (e.g., both close to baseline), a workload operating on a host with relatively small resources may consume more power than when the same workload is deployed on a host with a larger quantity of resources. Moreover, a single host may experience changes in its power consumption characteristics over time, such as when components of the host are swapped, updated, or upgraded, or when the components degrade over time due to continuous usage.

Nonetheless, use of the techniques of FIGS. 1-7, together with the additional techniques described below with respect to FIGS. 8 and 9, enable fast and accurate determinations of workloads and source/target hosts for load-balancing operations of the workload load balancer 802. As the host-specific power attribution models are specific to individual hosts, accurate power calculations may be determined for the same workload when deployed on different hosts. Further, the host-specific power attribution models may be updated whenever a host is modified, as may be determined from the corresponding host fingerprint.

Still further, described techniques of FIG. 8 may be used to identify degraded components that may, over time, result in decreased energy efficiency of a corresponding host(s). As described with respect to FIGS. 8 and 10, such identification of degraded components may be used to perform regular maintenance of corresponding host-specific power attribution models, as well as maintenance of the degraded components and/or hosts themselves.

FIG. 8 illustrates that during the process of model creation, energy-efficient operating ranges may be determined for components and corresponding hosts. For example, such energy-efficient operating ranges may be determined by performing a slope calculation(s) (804) with respect to component-specific power graphs of relevant components of a given host.

In other words, for each tracked component, a graph may be constructed of the power consumed by that component as a function of a utilization percentage of that component. Then, efficient operating ranges may be identified by finding intervals within each graph at which the slope is closest to zero, or minimized.

For example, such a graph may be constructed for a CPU, and divided into equal intervals (e.g., 10 equal intervals). A slope of each interval (e.g., between the first and last points of the interval) may then be calculated and stored. The slopes may be used to calculate load balancing parameters (806), and to otherwise perform load balancing, as discussed in more detail with respect to FIG. 9, below. The slopes may also be used to detect and quantify component degradation over time, as referenced above and described in more detail below, with respect to the model maintenance operations of FIG. 10.

In more detail, data collection for slope calculation may include utilization metrics for multiple components X1, X2, . . . , Xn (CPU, Memory, etc) along with a Power (Y) over a defined period. The data may thus be represented as (X_{i,t}, Yₜ) where (i=1, 2, . . . , n) for components and (t=1, 2, . . . , T) for time periods.

Then, slope calculations may proceed with interval creation, as referenced above. For example, for each component (Xᵢ), its range may be divided into ‘n’ (e.g., 10) equal intervals. If the range of (Xᵢ) is from (X_{i,min}) to (X_{i,max}), the intervals would be:

$${l}_{i , j} = [ {X}_{i , min} + \frac{j - 1}{10} ( {X}_{i , max} - {X}_{i , min} ) , {X}_{l , min} + \frac{j}{10} ( {X}_{i , max} - {X}_{i , min} ) ] \\ where ( j = 1 , 2 , … , 10 ) .$$

For each interval (I_{i,j}), the slope of Y with respect to (Xᵢ) may be calculated. The slope (S_{i,j}) for interval (I_{i,j}) may be calculated as:

$${s}_{i , j} = \frac{{Y}_{2} - {Y}_{1}}{{X}_{i , 2} - {X}_{i , 1}}$$

where (X_{i,1}, Y₁) and (X_{i,2}, Y₂) are near-adjacent values of (Xᵢ) and (Y) within the interval (I_{i,j}). This can be done for each interval to create a slope tracker for all components. The slopes (S_{i,j}) for each component (Xᵢ) and interval (j) may then be stored for subsequent use.

FIG. 9 is a flowchart illustrating example operations for load balancing, using partial attribution models and collected slope data of FIG. 8. Initially in FIG. 9, as described above, power as a function of component-specific utilization percentage may be determined for each component across all hosts (902). That is, during training of each host-specific power attribution model, many utilization metrics for each host may be collected and normalized to the relevant LCMTP and to percentages, in conjunction with collected power consumed by each corresponding physical host. This multidimensional data (e.g., collected across multiple components for each host) may be partitioned to two dimensions with each partition including utilization metrics for one component being one dimension and the other dimension being power consumption of the relevant host. Resulting data may be represented as a graph plot, with one dimension always being power.

Maximum power at each percentage may then be determined across the components for each host (904). For example, the above-referenced plots may be overlapped based on a maximum power value at each percentage. For example, for a given host with components CPU, memory, and disk, data may show maximum power at 60% utilization for each component as 200 W for the CPU, 150 W for memory, and 190 W for disk, so that 200 W may be chosen as the maximum power in this example. By choosing the maximum power value at each percentage across components, it becomes possible to characterize maximum power usage across a range of percentage utilization values. As noted above, in many cases it may be presumed that efficient power efficiency regimes occur between approximately 50% and 90% utilization percentages.

Then, within that range (or any suitable, defined range), efficient operating power region(s) for each host may be determined (906). As referenced above, such regions may be determined by finding areas of least slope and/or with the widest area possible, e.g., within defined intervals. All resulting, calculated information may be stored with the workload load balancer 802 of FIG. 8.

Load balancing may thus be provided to maximize use of efficient operating power regions of hosts and limit hosts to maximum power levels (908). In general, load balancing may include filling all suitable hosts for the workloads being scheduled until the hosts are at their efficient operating power and before adding more workloads to hosts already running at efficiency.

Different types of load balancing schemes may be used to provide load balancing. For example, bin packing is a type of algorithm that may be used. In some examples, workload power necessary for bin packing is obtained from historical calculated power using described techniques for power attribution to workloads. Two parallel views of the bins may be maintained. In one view, the maximum power is the determined efficient operating power region, and the other view is the maximum power the host can draw. When scheduling a workload, the efficient view may be consulted first, and all hosts may be filled evenly until if/when all hosts have reached the maximum of the efficient power-operating regions. Then, hosts may be filled to the maximum allowed power region. Once that level is reached for all hosts, subsequent workloads may be delayed in a queue of the workload load balancer 802 until space is available for deployment.

FIG. 10 is a flowchart illustrating example operations for maintenance of the partial attribution models of FIG. 8, including identification of degraded components. In general, as noted above, a host-specific power attribution model may be retrained quickly and as-needed. For example, upon restart of a host, any changes in the host's fingerprint resulting from changes to the components of the host may initiate a retraining of the corresponding model.

In addition, as referenced above, an energy efficiency of a host may degrade over time, so that, even if host components remain constant over time, the host-specific power attribution model of that host may become more and more inaccurate. For example, a particular component may degrade significantly, or multiple components may degrade minimally but may nonetheless have a composite effect on an accuracy of the relevant model.

In such cases, a modelled power of the host (e.g., the power predicted by a current host-specific power attribution model) may begin to diverge from an actual, measured power of that host. As shown in FIG. 10, the orchestrator 306 may periodically check for such divergences by using the corresponding model from the model database 310 to obtain modelled host power 1002, which may then be compared against measured host power 1004 from the metrics provider 304 to obtain a power divergence 1006 determined from the difference between the modelled host power 1002 and the measured host power 1004. For example, net utilization metrics for the host may be aggregated to the LCMTP, and the corresponding model may be applied to the aggregated metrics to determine the modeled host power 1002.

As long as the power divergence 1006 is less than some predefined power divergence threshold (e.g., 5% difference in the example of FIG. 10) (1008), the process may return (1010) to normal usage of the existing model. Otherwise, if the power divergence is greater than the power divergence threshold (1008), then the model may be re-trained (1012).

In some implementations, the model may be retrained at each such power divergence, and this process may continue until, e.g., the host is replaced according to an existing replacement schedule. In other example implementations, one or more specific degraded components may be detected, and the degraded component may be fixed or replaced to improve and/or restore the energy efficiency of the host.

For example, in conjunction with retraining the model, the previously determined slopes may be compared with current slope values (1014). That is, the slopes calculated and used to determine efficient operating ranges of components, as described with respect to FIG. 8, may be compared to similarly calculated current slope values.

If the net divergence is not greater than a user-configured value (1016), then the process may end/return (1018) to wait for a next-scheduled power divergence check. If the net divergence is greater than a user-configured value (1016), then degraded components may be identified (1020) based on the differences in slope values.

For example, continuing the examples and notation used above with respect to FIG. 8, a divergence check between slopes may include a comparison in which, for each period (t), current slopes

$$( {S}_{i , j}^{( c )} )$$

are calculated anu compared with previous slopes

$$( {S}_{i , j}^{( t - 1 )} ) .$$

The difference in slopes may thus be calculated as

$$Δ {S}_{i , j}^{( t )} = {S}_{i , j}^{( t )} - {S}_{i , j}^{( t - 1 )} .$$

This calculated difference represents an extent to which the relationship between (Xᵢ) and (Y) has changed over the interval (j) from time (t−1) to time (t). The differences

$$( Δ {S}_{i , j}^{( t )} )$$

may then be stored for each component (Xᵢ) and interval (j).

To assess degradation over time, the total change in slope from the oldest time period (t=1) to the most recent time period (t=T) may be calculated as:

$${Z}_{i} = {Σ}_{j = 1}^{10} \vert {S}_{i , j}^{( T )} - {S}_{i , j}^{( 1 )} \vert$$

in which (Zᵢ) represents the cumulative change in slopes for component (Xᵢ) over time. The absolute value is used to capture the magnitude of the change, regardless of direction.

Then, the component (Xᵢ) with the highest (Zᵢ) value may be identified as the one that has degraded the most over time. This indicates that the relationship between (Xᵢ) and (Y) has changed the most significantly, suggesting potential issues with this component.

Power divergence forecasting may also be provided. For example, during a maintenance phase, divergence data over a period is available. This divergence data may be used to do uni-variate forecasting to predict future divergence data for the next n hours (or) days. For example, if power divergence (and associated re-training of the model) occurs with increasing frequency (e.g., every week instead of every few months), failure of a component may be imminent. Therefore, as part of model-maintenance, future divergence value(s) may be predicted, and a user may be notified if the net divergence exceeds a user-specified value. This may be used as a trigger for the Z-score calculations described above, to thus identify the most degraded, and most likely to fail, component.

Implementations of the various techniques described herein may be implemented in digital electronic circuitry, or in computer hardware, firmware, software, or in combinations of them. Implementations may be implemented as a computer program product, i.e., a computer program tangibly embodied in an information carrier, e.g., in a machine-readable storage device, for execution by, or to control the operation of, data processing apparatus, e.g., a programmable processor, a computer, a server, a mainframe computer, multiple computers, or other kind(s) of digital computer(s). A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. Elements of a computer may include at least one processor for executing instructions and one or more memory devices for storing instructions and data. Generally, a computer also may include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory may be supplemented by or incorporated in special purpose logic circuitry.

To provide for interaction with a user, implementations may be implemented on a computer having a display device, e.g., a cathode ray tube (CRT) or liquid crystal display (LCD) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Implementations may be implemented in a computing system that includes a back-end component, e.g., as a data server, or that includes a middleware component, e.g., an application server, or that includes a front-end component, e.g., a client computer having a graphical user interface or a Web browser through which a user can interact with an implementation, or any combination of such back-end, middleware, or front-end components. Components may be interconnected by any form or medium of digital data communication, e.g., a communication network. Examples of communication networks include a local area network (LAN) and a wide area network (WAN), e.g., the Internet.

While certain features of the described implementations have been illustrated as described herein, many modifications, substitutions, changes, and equivalents will now occur to those skilled in the art. It is, therefore, to be understood that the appended claims are intended to cover all such modifications and changes as fall within the scope of the embodiments.

What is claimed is:

1. A computer program product, the computer program product being tangibly embodied on a non-transitory computer-readable storage medium and comprising instructions that, when executed by at least one computing device, are configured to cause the at least one computing device to:
generate a host-specific power attribution model for a host comprising components, the host-specific power attribution model relating host metrics characterizing operations of the components to host power consumed by the host;
receive partitioned host metrics of the host metrics that are associated with a workload being executed by the host; and
determine, using the host-specific power attribution model and the partitioned host metrics, a workload power of the host power that is used by the workload.

2. The computer program product of claim 1, wherein the instructions are further configured to cause the at least one computing device to:
determine a modelled workload power for the workload by processing the partitioned host metrics associated with the workload using the host-specific power attribution model; and
determine a second modelled workload power for a second workload executing on the host by processing second partitioned host metrics associated with the second workload using the host-specific power attribution model.

3. The computer program product of claim 2, wherein the instructions are further configured to cause the at least one computing device to:
determine the workload power based on a measured power of the host and a ratio of the modelled workload power to a sum of the modelled workload power and the second modelled workload power.

4. The computer program product of claim 1, wherein the instructions are further configured to cause the at least one computing device to:
capture the host metrics at corresponding intervals;
determine a least common multiple time period for the corresponding intervals; and
aggregate collected values of the host metrics using the least common multiple time period to generate the host-specific power attribution model.

5. The computer program product of claim 1, wherein the instructions are further configured to cause the at least one computing device to:
deploy at least one synthetic workload on the host, the at least one synthetic workload causing at least one of the components to execute across a range of utilization to thereby produce a corresponding range of component metrics; and
generate the host-specific power attribution model using the corresponding range of component metrics.

6. The computer program product of claim 1, wherein the instructions are further configured to cause the at least one computing device to:
generate a host fingerprint of the host based on the components.

7. The computer program product of claim 1, wherein the instructions are further configured to cause the at least one computing device to:
deploy the host-specific power attribution model to the host;
collect the partitioned host metrics at the host; and
generate the workload power at the host.

8. The computer program product of claim 1, wherein the instructions are further configured to cause the at least one computing device to:
collect the partitioned host metrics for the host across a batch time period during which the workload is executing;
process the partitioned host metrics using the host-specific power attribution model to obtain a modelled workload power;
determine a measured host power of the host; and
scale down the modelled workload power to obtain the workload power within the batch time period, using the measured host power.

9. The computer program product of claim 1, wherein the instructions are further configured to cause the at least one computing device to:
provide load balancing between the host and a second host by determining that a second workload power of a second workload would be less if deployed on the second host instead of the host; and
deploy the second workload to the second host.

10. The computer program product of claim 1, wherein the instructions are further configured to cause the at least one computing device to:
determine a divergence of a modelled host power, obtained using the host-specific power attribution model, and a measured host power of the host;
re-train the host-specific power attribution model in response to the divergence being detected; and
identify at least one degraded component of the components associated with the divergence.

11. A computer-implemented method, the method comprising:
generate a host-specific power attribution model for a host comprising components, the host-specific power attribution model relating host metrics characterizing operations of the components to host power consumed by the host;
receive partitioned host metrics of the host metrics that are associated with a workload being executed by the host; and
determine, using the host-specific power attribution model and the partitioned host metrics, a workload power of the host power that is used by the workload.

12. The method of claim 11, further comprising:
determining a modelled workload power for the workload by processing the partitioned host metrics associated with the workload using the host-specific power attribution model; and
determining a second modelled workload power for a second workload executing on the host by processing second partitioned host metrics associated with the second workload using the host-specific power attribution model.

13. The method of claim 12, further comprising:
determining the workload power based on a measured power of the host and a ratio of the modelled workload power to a sum of the modelled workload power and the second modelled workload power.

14. The method of claim 11, further comprising:
deploying at least one synthetic workload on the host, the at least one synthetic workload causing at least one of the components to execute across a range of utilization to thereby produce a corresponding range of component metrics; and
generating the host-specific power attribution model using the corresponding range of component metrics.

15. The method of claim 11, further comprising:
deploying the host-specific power attribution model to the host;
collecting the partitioned host metrics at the host; and
generating the workload power at the host.

16. The method of claim 11, further comprising:
collecting the partitioned host metrics for the host across a batch time period during which the workload is executing;
processing the partitioned host metrics using the host-specific power attribution model to obtain a modelled workload power;
determining a measured host power of the host; and
scaling down the modelled workload power to obtain the workload power within the batch time period, using the measured host power.

17. A system comprising:
at least one memory including instructions; and
at least one processor that is operably coupled to the at least one memory and that is arranged and configured to execute instructions that, when executed, cause the at least one processor to:
generate a host-specific power attribution model for a host comprising components, the host-specific power attribution model relating host metrics characterizing operations of the components to host power consumed by the host;
receive partitioned host metrics of the host metrics that are associated with a workload being executed by the host; and
determine, using the host-specific power attribution model and the partitioned host metrics, a workload power of the host power that is used by the workload.

18. The system of claim 17, wherein the instructions, when executed, are further configured to cause the at least one processor to:
determine a modelled workload power for the workload by processing the partitioned host metrics associated with the workload using the host-specific power attribution model;
determine a second modelled workload power for a second workload executing on the host by processing second partitioned host metrics associated with the second workload using the host-specific power attribution model; and
determine the workload power based on a measured power of the host and a ratio of the modelled workload power to a sum of the modelled workload power and the second modelled workload power.

19. The system of claim 17, wherein the instructions, when executed, are further configured to cause the at least one processor to:
deploy at least one synthetic workload on the host, the at least one synthetic workload causing at least one of the components to execute across a range of utilization to thereby produce a corresponding range of component metrics; and
generate the host-specific power attribution model using the corresponding range of component metrics.

20. The system of claim 17, wherein the host-specific power attribution model includes a multiple linear regression model.
